(19) United States
(12) Patent Application Publication
(10) Pub. No.: US 2011/0296174 A1
(43) Pub. Date: Dec. 1, 2011

(54) COMMUNICATION APPARATUS AND COMMUNICATION METHOD

(75) Inventor: Fumiharu Nakayama, Kanagawa-ken (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/101,277

(22) Filed: May 5, 2011

Related U.S. Application Data
(60) Provisional application No. 61/350,187, filed on Jun. 1, 2010.

(30) Foreign Application Priority Data
Mar. 3, 2011 (JP) P2011-046398

(51) Int. Cl. H04L 9/00

(52) U.S. Cl. 713/162; 713/165

(57) ABSTRACT

A communication apparatus that stores at least one address of transmission destination and at least one file to be transmitted that are obtained from an external device via an interface into a memory, determines whether a password for encrypting a transmission file is obtained by using a controller when receiving a file transmission instruction, and when obtaining the password, encrypts the transmission file by using the obtained password and transmits the encrypted transmission file to a transmission destination terminal.

### CROSS-REFERENCE TO RELATED APPLICATION

The application is based upon and claims the benefit of priority from U.S. Provisional Application No. 61/350,187, filed Jun. 1, 2010; further this application is based upon and claims the benefit of priority from Japanese Patent Application No. P2011-046398, filed on Mar. 3, 2011; the entire contents of which are incorporated herein by references.

### FIELD

Embodiments of a present specification are generally related with a communication apparatus that performs communication via a network and a communication method thereof.

### BACKGROUND

There is a technique for transferring a file of media data such as voice, text, image, and video between IP communication apparatuses by using SIP (Session Initiation Protocol). However, in such a technique, to secure the security of the transferred medium file, an operation is required in which a user makes an encrypted and compressed transmission file by encrypting and compressing the file to be transferred after attaching a pass code necessary for decompressing and decoding to the file by an application or the like in advance. Thereafter, the user issues an instruction for transmitting the made transmission file.

### BRIEF DESCRIPTION OF THE DRAWINGS

FIG. 1 is a block diagram for explaining a configuration of a communication system.

FIG. 2 is a block diagram for explaining a hardware configuration of a communication apparatus according to a first embodiment.

FIG. 3 is a block diagram for explaining a hardware configuration of a user terminal according to the first embodiment.

FIG. 4 is a block diagram for explaining a hardware configuration of a multifunction apparatus according to the first embodiment.

FIG. 5 is a flowchart for explaining processing of the communication apparatus according to the first embodiment when instructing file transmission from the multifunction apparatus to the communication apparatus by using a Web browser function.

FIG. 6 is a user interface screen in which file transmission is instructed from the multifunction apparatus according to the first embodiment by using a Web browser function.

FIG. 7 is a sequence diagram showing communication processing from the start to the end of transmission of a first file.

FIG. 8 is a sequence diagram showing processing from the start to the end of transmission and communication of a second file.

FIG. 9 is a flowchart for explaining processing of a communication apparatus according to a second embodiment when instructing file transmission from a multifunction apparatus to the communication apparatus by using a Web browser function.

FIG. 10 shows a user interface screen in which file transmission is instructed from an operation panel of the multifunction apparatus according to the second embodiment by using a Web browser function.

FIG. 11 shows a user interface screen in which file transmission is instructed from the operation panel of the multifunction apparatus according to the second embodiment by using a Web browser function.

FIG. 12 shows a user interface screen in which file transmission is instructed from the operation panel of the multifunction apparatus according to the second embodiment by using a Web browser function.

FIG. 13 is a flowchart for explaining processing of a communication apparatus according to a third embodiment when instructing file transmission from a user terminal to the communication apparatus by using a Web browser function.

FIG. 14 shows a user interface screen in which file transmission is instructed from the user terminal according to the third embodiment by using a Web browser function.

### DETAILED DESCRIPTION

An object to be achieved by an embodiment to which the present invention is applied is to provide a communication apparatus and a communication method for automatically compressing and encrypting a file and transferring the file with a password to a receiving terminal when a transmitting terminal receives an instruction for transmitting a file. Based on this, a user need not perform an operation of preparing a compressed file or the like in advance, so that convenience of the user increases.

To achieve the above object, the communication apparatus of an embodiment includes an interface for connecting with an external device and a transmission destination terminal via a network, a memory for storing at least one address of a transmission destination and at least one file to be transmitted that are obtained from the external device via the interface, and a controller for determining whether a password for encrypting a transmission file in the memory is obtained when the controller receives a transmission instruction of a file via the interface, and when the password is obtained, encrypting the transmission file by using the obtained password, and transmitting the encrypted transmission file to a transmission destination terminal of the address via the interface.

Hereinafter, embodiments of the present invention will be described with reference to the drawings.

### First Embodiment

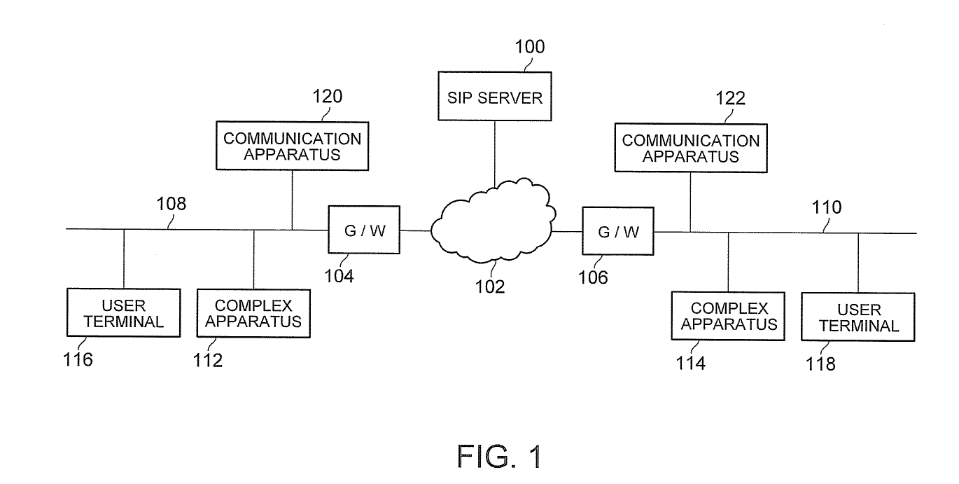

FIG. 1 is a block diagram for explaining an example of a configuration of a communication system. The communication system includes a SIP (Session Initiation Protocol) server 100, a network 102, G/Ws (Gateways) 104 and 106, communication apparatuses 120 and 122, multifunction apparatuses 112 and 114, and user terminals 116 and 118. The communication apparatus 120, the multifunction apparatus 112, and the user terminal 116 are connected to the network 102 via the LAN 108 and the G/W 104. The communication apparatus 122, the multifunction apparatus 114, and the user terminal 118 are connected to the network 102 via the LAN 110 and the G/W 106. The SIP server 100 communicates with the communication apparatuses 120 and 122 via the network 102. Although the system shown in FIG. 1 includes two communication apparatuses, two multifunction apparatuses, and two user terminals connected to the network 102, the numbers of the communication apparatuses, the multifunction apparatuses, and the user terminals may be three or more. The communication apparatus is connected to at least one of the multifunction apparatus and the user terminal. The network 102 may be NGN (Next Generation Network) which is a dedicated network for telecommunications carriers, or may be the publicly known Internet. In the description of FIG. 1, the network 102 is assumed to be NGN as an example.

The G/Ws 104, 106 adjust various differences between the LANs 108, 110 and the network 102. The G/Ws 104 and 106 enable devices connected to the LANs 108 and 110 to perform communication via the network 102. The G/Ws 104 and 106 may include a port to which an analog communication terminal is connected. In this case, the G/Ws 104 and 106 enable the analog communication terminal to perform communication via the network 102.

The communication apparatuses 120 and 122 establish a session by transmitting and receiving a SIP message to and from each other via the SIP server 100 in call control processing, and transfer media data (voice, text, image, video, and the like) (hereinafter referred to as “file transfer”) in communication processing thereafter. For example, the communication apparatus 120 transmits media data from the multifunction apparatus 112 and the user terminal 116 to the communication apparatus 122 via the network 102. The communication apparatus 122 has the same function as that of the communication apparatus 120.

The SIP server 100 relays a SIP message for a call connection between the communication apparatuses 120 and 122. The SIP server 100 manages information such as the global address, the port number, the type of NAT (Network Address Translation) of the communication apparatuses 120 and 122 (the SIP server 100 performs registration, update, and deletion of information in the location server).

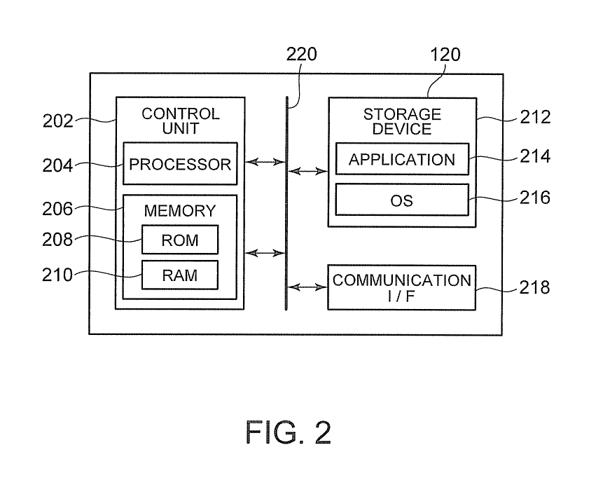

FIG. 2 is a block diagram for explaining a hardware configuration of the communication apparatuses 120 and 122 according to the first embodiment. Here, the communication apparatus 120 will be described as an example.

The communication apparatus 120 includes software and hardware for performing communication with devices on the LAN 108, the SIP server 100, and the communication apparatus 122, or an appropriate combination of these.

The communication apparatus 120 includes a control unit 202, a storage device 212, and a communication interface (communication I/F) 218.

The control unit (controller) 202 has a processor 204 including a CPU (Central Processing Unit) or a MPU (Micro Processing Unit) and a memory 206. The control unit 202 processes a document including graphics, images, characters, tables, and the like. The control unit 202 controls processing of file transfer with the other side communication apparatus. The memory 206 is, for example, a semiconductor memory, and includes a ROM (Read Only Memory) 208 for storing various control programs and a RAM (Random Access Memory) 210 for providing a temporary work area to the processor 204. The components in the communication apparatus 120 are connected to each other via a bus 220.

The storage device 212 stores an application program 214 and an OS (Operating System) 216. The application program 214 works as software of the OS 216. The application program 214 includes a Web application program in addition to general software. The application program 214 includes a program for forming a screen displayed on the multifunction apparatus 112 or the user terminal 116 on the LAN 108. The storage device 212 stores media data (voice data, text data, image data, video data, and the like) obtained via the communication I/F 218. The storage device 212 stores, for example, media data transmitted from the communication apparatus 122 and media data received from the multifunction apparatus 112 or the user terminal 116 on the LAN 108. The storage device 212 may be, for example, a hard disk drive or another magnetic storage device, an optical storage device, a semiconductor storage device such as a flash memory, or an arbitrary combination of these. The communication apparatus 120 may use a server, a PC, or another storage device connected via the communication I/F 218 instead of the storage device 212.

The communication I/F 218 is an interface for connecting with external devices. The communication I/F 218 includes an appropriate wired or wireless interface compliant with IEEE 802.15, IEEE 802.11, IEEE 802.3, IEEE 1284, or the like including, for example, Bluetooth (registered trademark), infrared connection, and optical connection. The communication I/F 218 may further include a USB connection portion to which a USB standard connection terminal is connected, a parallel interface, and the like. The communication I/F 218 transmits and receives media data to and from an external device such as the user terminal 116 or the multifunction apparatus 112. The control unit 202 communicates with the G/W 108, the SIP server 100, the other side device (for example, the communication apparatus 122), and other external devices via the communication I/F 218 in accordance with a predetermined communication protocol.

The control unit 202 exchanges SIP messages with the SIP server 100 and the other side device, and establishes a session.

The control unit 202 generates a transmission file from media data received from the multifunction apparatus 112 or the user terminal 116. Data from the multifunction apparatus 112 includes image data obtained by scanning an original document by the multifunction apparatus. When the scanned data has a plurality of pages, the control unit 202 receives media data from the multifunction apparatus 112 as a single file. Or, on the basis of a read condition of the multifunction apparatus 112, the control unit 202 may receive the media data as a plurality of files on a page by page basis. The control unit 202 compresses and encrypts the transmission file before transmitting the file by using the application program stored in the storage device 212 on the basis of an instruction of a user.

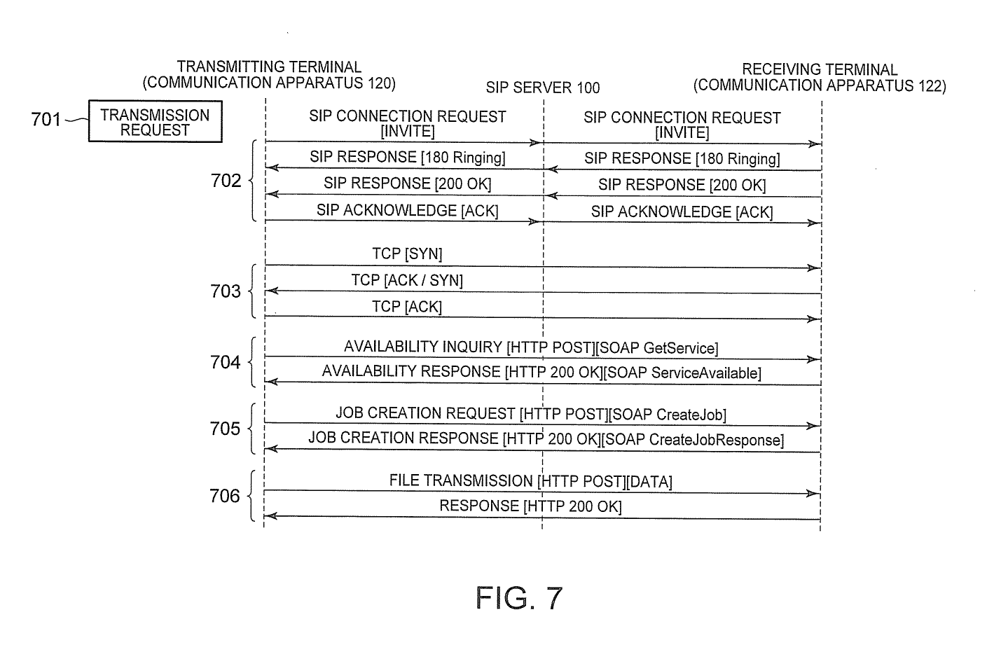

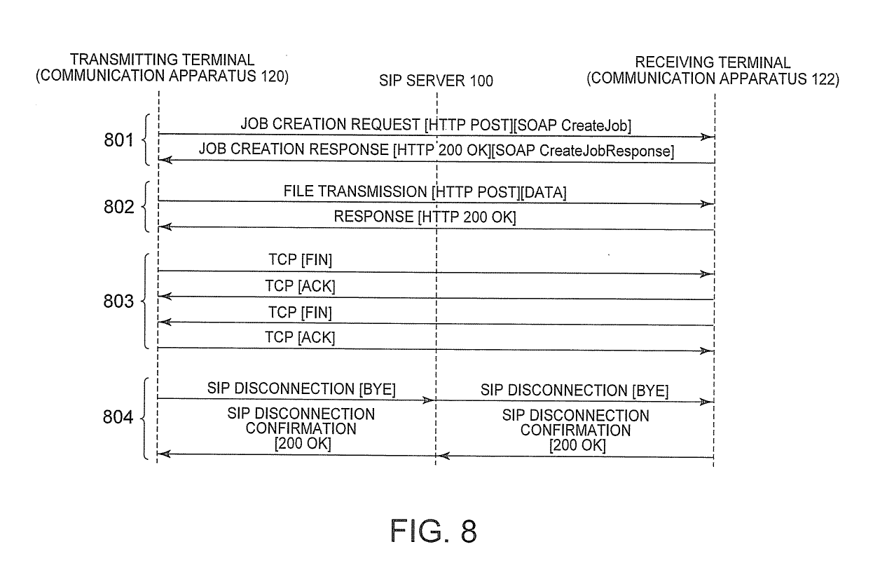

Subsequently, the control unit 202 performs processing for packetizing and transmitting the media data generated as a file. The control unit 202 checks for arrival of data, overlapping of data, missing of data, and the like on the basis of TCP (Transmission Control Protocol). The control unit 202 uses, for example, a protocol defined by RFC3261. As described below in FIGS. 7 and 8, for example, the control unit 202 exchanges one or more pieces of availability information related to a file transfer function and information of the file to be transferred (for example, filename, file format, and file size) with the other side device by using a SDP (Session Description Protocol) document on the SIP message.

The control unit 202 stores a file received from the other side device into the storage device 212. When the control unit 202 receives an instruction for performing printing from the other side device, the control unit 202 transfers the file to a predetermined image forming device. The image forming device (for example, the multifunction apparatus 112) that receives the transferred file generates image data for printing and prints the image data on a sheet.

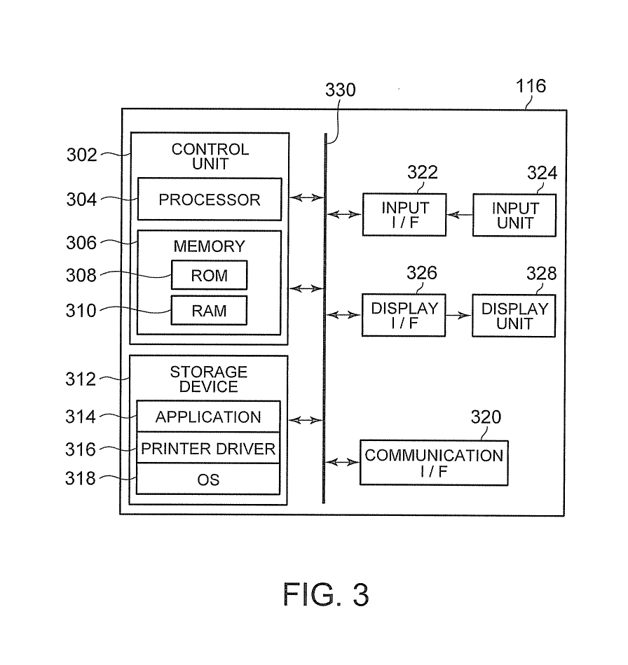

FIG. 3 is a block diagram for explaining a hardware configuration of the user terminals 116 and 118 according to the first embodiment. Examples of the user terminals 116 and 118 include a desktop PC (Personal Computer), a laptop PC, a tablet PC, a mobile phone, a PDA (Personal Digital Assistant), and a media player. Here, the user terminal 116 will be described by using a PC as an example.

The user terminal 116 includes software and hardware for performing communication with the communication apparatus 120 and the multifunction apparatus 112 or an appropriate combination of these. The user terminal 116 also includes a Web browser for communicating with various web pages and device pages or an appropriate interface to other special applications.

The user terminal 116 includes a control unit 302, a storage device 312, a communication interface (communication I/F) 320, an input interface (input I/F) 322, an input unit 324, a display interface (display I/F) 326, and a display unit 328.

The control unit (controller) 302 has a processor 304 including a CPU (Central Processing Unit) or a MPU (Micro Processing Unit) and a memory 306. The control unit 302 processes a document including graphics, images, characters, tables, and the like. The memory 306 is, for example, a semiconductor memory, and includes a ROM (Read Only Memory) 308 for storing various control programs and a RAM (Random Access Memory) 310 for providing a temporary work area to the processor 304. The components in the user terminal 116 are connected to each other via a bus 330.

The storage device 312 stores an application program 314, a printer driver 316, and an OS (Operating System) 318. The application program 314 works as software of the OS 318. The application program 314 includes a Web browser, a Web application program in addition to general software. The printer driver 316 is a device driver for controlling the multifunction apparatus 112 in accordance with a print instruction from the application program 314, and works as software of the OS 318. The storage device 312 may be, for example, a hard disk drive or another magnetic storage device, an optical storage device, a semiconductor storage device such as a flash memory, or an arbitrary combination of these.

The communication I/F 320 is an interface for connecting with external devices. The communication I/F 320 communicates with the multifunction apparatus 112 via an appropriate wireless or wired interface compliant with IEEE 802.15, IEEE 802.11, IEEE 802.3, IEEE 3304, or the like including, for example, Bluetooth (registered trademark), infrared connection, and optical connection. The communication I/F 320 may further include a USB connection portion to which a USB standard connection terminal is connected, a parallel interface, and the like. The control unit 302 communicates with the multifunction apparatus 112, a USB device, and the other external devices via the communication I/F 320.

The input I/F 322 is connected to the input unit 324. For the input unit 324, a keyboard device and a mouse are used as a man-machine interface.

The display I/F 326 is connected to the display unit 328. The display I/F 326 receives data or an instruction to be displayed on the display unit 328 from the other components connected to the bus 330. The display I/F 326 outputs display data to the display unit 328. As the display unit 328, for example, a display attached to the PC is used.

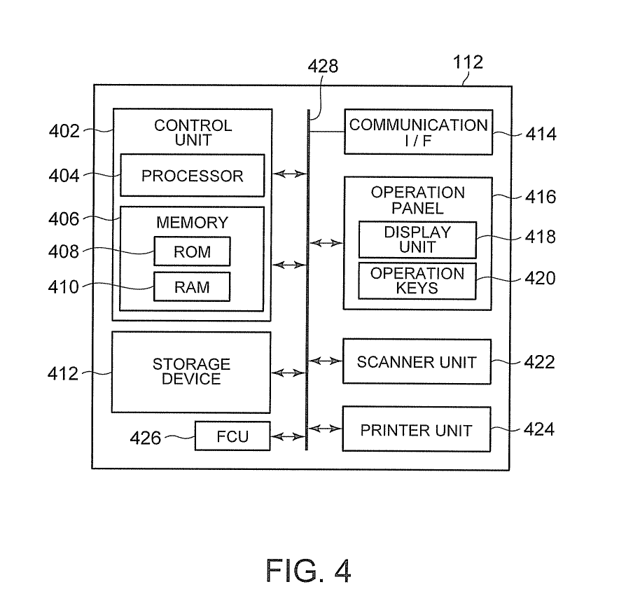

FIG. 4 is a block diagram for explaining a hardware configuration of the multifunction apparatuses 112 and 114 according to the first embodiment. Here, the multifunction apparatus 112 will be described as an example.

The multifunction apparatus 112 includes a control unit 402, a storage device 412, a communication interface (communication I/F) 414, an operation panel 416, a scanner unit 422 for reading an original document, a printer unit 424 for forming an image, and a facsimile control unit (FCU) 426. The components in the multifunction apparatus 112 are connected to each other via a bus 428.

The control unit 402 has a processor 404 including a CPU (Central Processing Unit) or a MPU (Micro Processing Unit) and a memory 406. The memory 406 is, for example, a semiconductor memory, and includes a ROM (Read Only Memory) 408 for storing a control program of the processor 404 and a RAM (Random Access Memory) 410 for providing a temporary work area to the processor 404. The control unit 402 controls the operation panel 416, the scanner unit 422, the printer unit 424, and the facsimile control unit (FCU) 426 on the basis of the control program and the like stored in the ROM 408 or the storage device 412. The control unit 402 further includes a function for correcting or decompressing image data.

The storage device 412 stores an application program and an OS. The application program includes programs for executing functions included in the multifunction apparatus, such as a copy function, a print function, a scanner function, a facsimile function, and a network file function. The application program further includes an application (Web browser) for a Web client and the other applications.

The storage device 412 temporarily stores image data of an original document read by the scanner unit 422 or image data obtained via the communication I/F 414. The storage device 412 may be, for example, a magnetic storage device such as a hard disk drive, an optical storage device, a semiconductor storage device (flash memory or the like), or an arbitrary combination of these storage devices. The storage device 412 appropriately stores software update information, protected electronic document, text data, account information, policy information, and the like.

The communication I/F 414 is an interface for connecting with external devices. The communication I/F 414 communicates with external devices via an appropriate wireless or wired interface compliant with IEEE 802.15, IEEE 802.11, IEEE 802.3, IEEE 1284, or the like including, for example, Bluetooth (registered trademark), infrared connection, and optical connection. The communication I/F 414 may further include a USB connection portion to which a USB standard connection terminal is connected, a parallel interface, and the like. The control unit 402 communicates with the communication apparatus 120, the user terminal 116, a USB device, and the other external devices via the communication I/F 414.

The operation panel 416 includes a touch panel type display unit 418 and various operation keys 420. The operation keys 420 include, for example, a numeric keypad, a reset key, a stop key, a start key, and the like. The display unit 418 displays instruction items related to a printing condition such as, for example, a paper size, the number of copies, a print density setting, a finishing (binding, folding), and the like. The display unit 418 also displays instruction items related to a file transmission condition such as a destination address for transmitting a facsimile or transmitting a file, a read setting of a file to be transmitted, and a processing setting that specifies how the transmission destination processes the transmitted file. Instructions of the displayed items are inputted from the display unit 418.

The scanner unit 422 includes a built-in scanning read unit for reading an original document as an image, an original document placement table, and an automatic original document feeder for transporting an original document to a reading position. The scanning read unit of the scanner unit 422 reads an original document set on the original document placement table or the automatic original document feeder.

The printer unit 424 includes, for example, an image forming unit including a photosensitive drum and a development unit using toner, which are publicly known. The printer unit 424 forms an image corresponding to image data of an original document read by the scanner unit 422 and an image corresponding to image data transmitted from the user terminal 116 on a sheet by these units. The printer unit 424 also prints a file obtained from the communication apparatus 120 via the communication I/F 414 on a sheet.

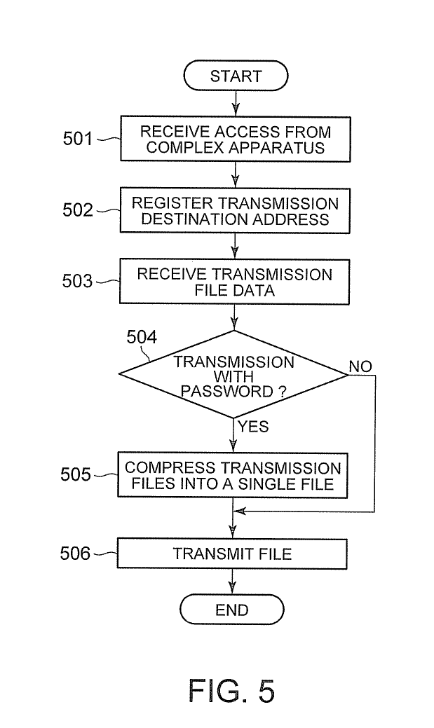

Next, a case will be described in which image data of an original document scanned by the multifunction apparatus 112 is transmitted as a file. FIG. 5 is a flowchart for explaining processing in which the communication apparatus 120, which is a transmitting terminal, transfers a file to the communication apparatus 122, which is a receiving terminal when the communication apparatus 120 is instructed to transmit a file from the operation panel of the multifunction apparatus 112 by using a Web browser function.

In 501 of FIG. 5, when the multifunction apparatus 112 receives a user instruction via the operation panel 416, the multifunction apparatus 112 accesses the communication apparatus 120 by using the Web browser function. In other words, the communication apparatus 120 receives an access from the multifunction apparatus. In the multifunction apparatus 112, the user sets an original document on the scanner unit 422.

In 502, the communication apparatus 120 accepts a registration of an address of the transmission destination via the operation panel 416 of the multifunction apparatus 112. The user directly inputs the address of the transmission destination via the operation panel 416 of the multifunction apparatus 112, or registers the destination address into the communication apparatus 120 by selecting the destination address from an address book or a transmission/reception history stored in the communication apparatus 120. The address book used to select the destination address is not limited to the address book stored in the communication apparatus 120, and the destination address may be selected from an address book stored in the user terminal 116 or the multifunction apparatus 112. A plurality of destination addresses may be registered at the same time.

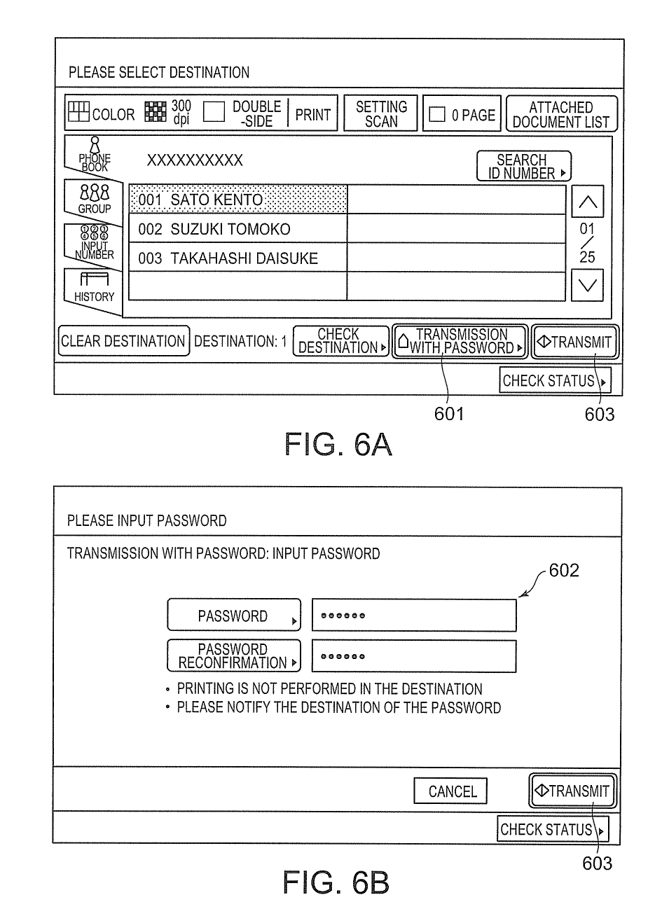

FIG. 6 is an example of a user interface screen in which file transmission is instructed from the operation panel 416 of the multifunction apparatus 112 by using a Web browser function. As shown in FIG. 6A, as an example in this embodiment, a telephone number XXXXXXXXXX of the communication apparatus 122 is registered as a destination address.

Reference numeral 601 in FIG. 6A denotes a button for setting a “transmission with password” function. When the button 601 is operated, a user interface screen of FIG. 6B in which a password is inputted is displayed, and a password can be accepted. To enable the “transmission with password” function, the user inputs a password into an input field 602. Reference numeral 603 in FIGS. 6A and 6B denotes a button for instructing the communication apparatus 120 to perform file transmission processing.

Next, as shown in FIG. 5, the communication apparatus 120 receives data of a transmission file from the multifunction apparatus in 503. Specifically, when the transmit button 603 in FIG. 6 is operated, the scanner unit 422 of the multifunction apparatus 112 reads an original document set on the original document placement table or the automatic original document feeder. If the multifunction apparatus 112 does not accept a detailed read setting, the multifunction apparatus 112 scans the original document with a predetermined setting (default setting). The default setting items include, for example, a color mode for setting a mode to read the original document, which is selected from modes such as color, monochrome, and gray scale, a single-side/double-side setting for setting whether the original document is single-sided or double-sided, and a reading resolution. The multifunction apparatus 112 transmits image data of the original document read by the scanner unit 422 to the communication apparatus. The communication apparatus 120 receives the image data transmitted from the multifunction apparatus 112, and stores the image data into the storage device 212 as the transmission file.

In 504, the control unit 202 of the communication apparatus 120 determines whether the setting of “transmission with password” is enabled. For example, the control unit 202 determines whether there is a password inputted into the input field 602 in FIG. 6.

If the “transmission with password” is not set (No in 504), in 506, the control unit 202 of the communication apparatus 120 transmits the transmission file to the communication apparatus 122 which is a registered destination via the communication I/F 218.

If the “transmission with password” is set (Yes in 504), when a plurality of transmission files is transmitted from the multifunction apparatus 112 as described above, the control unit 202 of the communication apparatus 120 compresses the files to be transmitted into a single file with a predetermined format with the password inputted into the input field 602 (505). For example, the control unit 202 compresses the files to be transmitted into a single file and encrypts the file by using the password inputted into the input field 602. The file format of the compressed file may be, for example, ZIP, RAR, AFA, CAB, GCA, DGCA, LHA, and the other common lossless compression methods. Next, in 506, the control unit 202 of the communication apparatus 120 transmits the compressed transmission file to the communication apparatus 122 via the communication I/F 218. On the receiving terminal side, a user who receives the password in a different way such as e-mail inputs the password when decompressing the file. If the inputted password is correct, the compressed file is decompressed into the original plurality of files.

Next, the processing in 506 will be described in which the communication apparatus 120 transmits the transmission file to the communication apparatus 122 via the communication I/F 218.

FIGS. 7 and 8 are sequence diagrams showing communication processing in the communication system of FIG. 1. FIG. 7 shows transmission processing of a first file until the transmission is completed. FIG. 8 shows transmission processing of a second file and processing until the communication is finished after the second file has been transmitted. In other words, FIGS. 7 and 8 are a series of processing for transmitting a plurality of files in one job. In this example, the communication apparatus 120 (hereinafter referred to as a transmitting terminal) which operates as a transmitting terminal and the communication apparatus 122 (hereinafter referred to as a receiving terminal) which operates as a receiving terminal perform registration processing (transmission of a REGISTER command or the like) to the SIP server 100 in advance.

When a user instructs the communication apparatus 120 to transmit a file by using a Web browser function from the user terminal 116 or the multifunction apparatus 112, as shown in FIG. 7, in 701, the transmitting terminal dials the destination number of the receiving terminal to send a call request (transmission request).

In 702, the transmitting terminal transmits an INVITE command for starting a session, and exchanges a series of SIP commands with the receiving terminal via the SIP server 100. Subsequently, the called party is called from the SIP server, and a 180 Ringing command which indicates that the called party is being called is transmitted to the transmitting terminal via the SIP server. Next, when the transmitting terminal receives a 200 OK command via the SIP server, the transmitting terminal recognizes that the communication is established, and transmits an ACK command to the SIP server as a response command. In this way, a SIP call connection is completed.

In 703, the transmitting terminal and the receiving terminal establish a connection. Establishing a connection means that a logical communication path (connection) for performing communication is set between the transmitting terminal and the receiving terminal. The transmitting terminal sends a SYN command in which a port number of the receiving terminal to be connected and a sequence number of the transmitting terminal are specified to try to establish an upstream connection. The receiving terminal tries to establish a downstream connection by responding to the SYN command from the transmitting terminal with an ACK command that acknowledges the establishment of the upstream connection and sending a SYN command in which a sequence number of the receiving terminal is specified. The transmitting terminal responds to the SYN command from the receiving terminal with an ACK command that acknowledges the establishment of the downstream connection. Here, for convenience, the transfer direction from the transmitting terminal to the receiving terminal is referred to as upstream, and the opposite transfer direction is referred to as downstream. Based on the above processing, the connection is established before transferring data such as a file.

In 704, the transmitting terminal transmits a SOAP Get Service command for inquiring availability and exchanges a series of SOAP commands with the receiving terminal. When the transmitting terminal receives a SOAP Service Available command which is an availability response, the transmitting terminal obtains an availability file of the receiving terminal. When the receiving terminal receives a SOAP Get Service command, the receiving terminal obtains an availability file of the transmitting terminal.

In 705, the transmitting terminal requests the receiving terminal to allow the start of a job by a SOAP Create Job command (job creation request). The SOAP Create Job command includes attributes necessary for starting a job, such as, for example, a user name, a job name, a file name, a format of transmission file (for example, tiff or the like), the size of the first file to be transmitted, and a processing condition associated with the first file.

When the receiving terminal receives the SOAP Create Job command, the receiving terminal recognizes the attribute of the first file transmitted from the transmitting terminal. The receiving terminal checks the size of the first transmission file included in the SOAP Create Job command and the capacity of the memory or the storage device of the receiving terminal, and when the free space is sufficient, the receiving terminal transmits a SOAP Create Job Response command that allows the start of the job to the transmitting terminal (job creation response).

When the transmitting terminal receives the SOAP Create Job Response command, the transmitting terminal recognizes that the job creation request is allowed. When a session is established by the above communication, in 706, the transmitting terminal transmits the first transmission file to the receiving terminal.

The receiving terminal stores the received first file into the storage device of the receiving terminal or transmits the first file to the multifunction apparatus 114 on the basis of the processing condition. The receiving terminal notifies the transmitting terminal that the receiving terminal has received the first file.

When the transmission of the first transmission file is completed, as shown in 801 in FIG. 8, the transmitting terminal requests the receiving terminal to allow the start of a job by a SOAP Create Job command (job creation request). The SOAP Create Job command includes attributes necessary for starting a job, such as, for example, a user name, a job name, a file name, a format of transmission file (for example, tiff or the like), the size of the second file to be transmitted, and a processing condition, associated with the second file.

When the receiving terminal receives the SOAP Create Job command, the receiving terminal recognizes the attribute of the second file transmitted from the transmitting terminal. The receiving terminal checks the size of the second transmission file included in the SOAP Create Job command and the capacity of the memory or the storage device of the receiving terminal, and when the free space is sufficient, the receiving terminal transmits a SOAP Create Job Response command that allows the start of the job to the transmitting terminal (job creation response).

When the transmitting terminal receives the SOAP Create Job Response command, the transmitting terminal recognizes that the job creation request is allowed. When a session is established by the above communication, in 802, the transmitting terminal transfers the second transmission file to the receiving terminal.

The receiving terminal stores the received second file into the storage device of the receiving terminal or transmits the second file to the multifunction apparatus 114 on the basis of the processing condition. The receiving terminal notifies the transmitting terminal that the receiving terminal has received the second file.

When the transmission of the second file is finished, in other words, when the data transmission is completed, the connection used for the communication is closed in 803. First, the transmitting terminal transmits a FIN command that ends the data transmission to the receiving terminal. When the receiving terminal receives the FIN command, the receiving terminal responds to the transmitting terminal with an ACK command that acknowledges the end of the upstream connection. Subsequently, the receiving terminal transmits a FIN command to the transmitting terminal. When the transmitting terminal receives the FIN command, the transmitting terminal responds to the receiving terminal with an ACK command that acknowledges the end of the downstream connection. In this way, when the transmitting terminal and the receiving terminal send the FIN command to each other and receive the ACK command for acknowledging the FIN command, the connection between the transmitting terminal and the receiving terminal is closed. Next, the transmitting terminal performs communication for closing the session of SIP connection (804). The processing for connecting and closing the communication is only an example of the embodiment, and it is not limited to this.

In FIGS. 7 and 8 described above, the processing in which a plurality of files is separately transmitted in one job of communication processing is described. In a case of transmission with password, a plurality of files is compressed into a single file. Therefore, when transmitting the compressed file, the processing of 801 and 802 in FIG. 8 is not performed.

According to the above-described embodiment, when securing the security of the file to be transferred, the transmission with password is set by inputting a password when the multifunction apparatus scans an original document on the transmission side, and thereby the transmitting terminal obtains image data of the scanned original document from the multifunction apparatus, automatically compresses and encrypts the image data, and transfers the file to the receiving terminal as a file with a password. Therefore, after a user instructs the multifunction apparatus to scan the original document, the user need not instruct any device to compress the transmission file, so that the usability is good.

### Second Embodiment

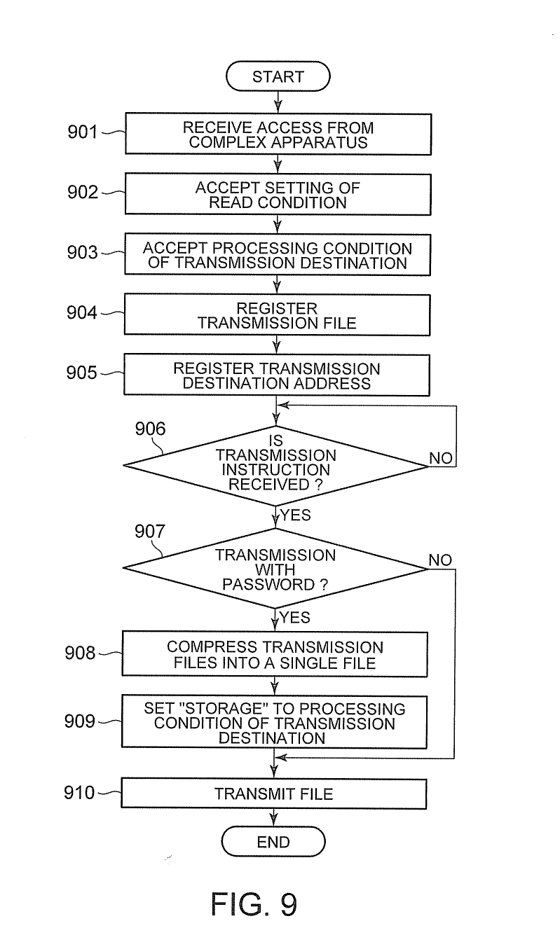

Next, another embodiment will be described in which image data of an original document scanned by the multifunction apparatus 112 is transmitted as a file. FIG. 9 is a flowchart for explaining processing in which the communication apparatus 120, which is a transmitting terminal, transfers a file to a communication apparatus, which is a receiving terminal when the communication apparatus 120 (transmitting terminal) is instructed to transmit a file from the operation panel of the multifunction apparatus 112 by using a Web browser function.

In 901, when the multifunction apparatus 112 receives a user instruction via the operation panel 416, the multifunction apparatus 112 accesses the communication apparatus 120 by using the Web browser function. In other words, the communication apparatus 120 receives an access from the multifunction apparatus. In the multifunction apparatus 112, the user sets an original document on the scanner unit 422.

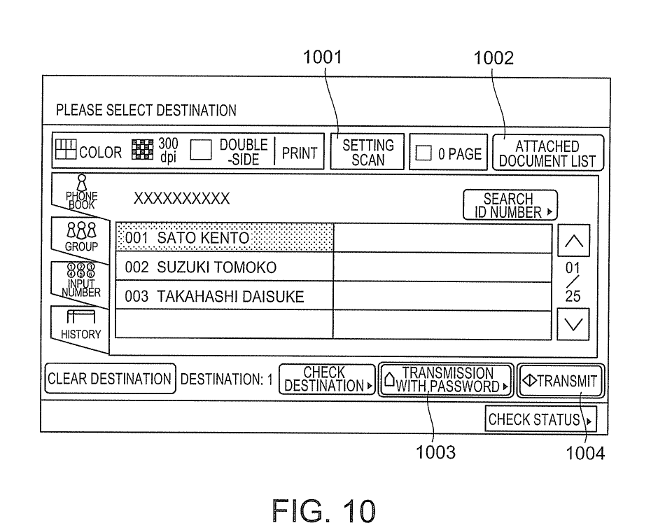

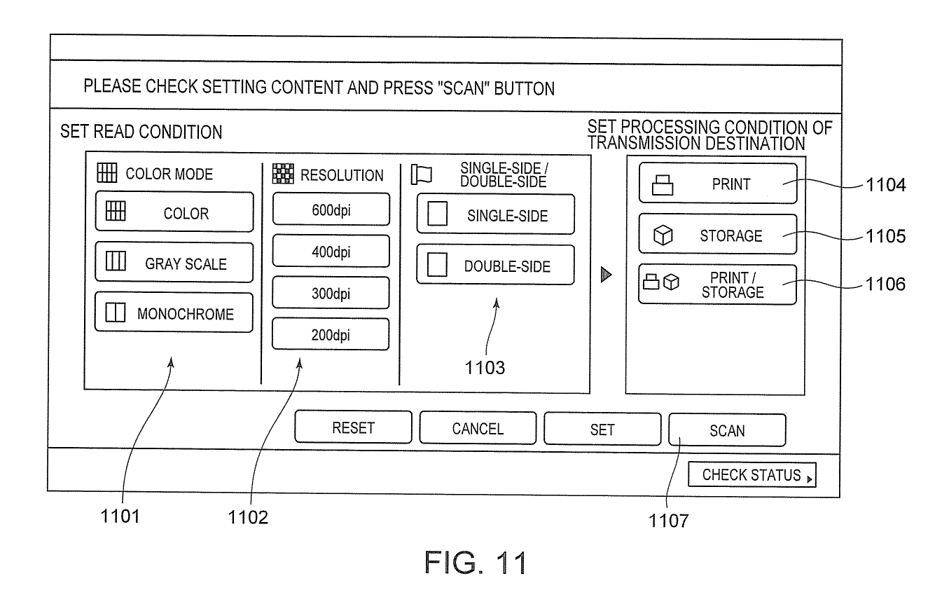

In 902, the communication apparatus 120 accepts a setting of a read condition of the file to be transmitted via the operation panel 416 of the multifunction apparatus 112. FIGS. 10 to 12 are an example of user interface screens in which file transmission is instructed from the operation panel 416 of the multifunction apparatus 112 by using a Web browser function. Reference numeral 1001 in FIG. 10 denotes a button for setting a read condition of an original document and a processing condition indicating how the transmitted file is processed in the transmission destination. When the button 1001 is operated, a user interface screen of FIG. 11 in which the read condition and the processing condition are set is displayed, and the read condition can be set or changed. The setting items of the read condition include, for example, a color mode 1101 for setting a mode to read the original document, which is selected from modes such as color, monochrome, and gray scale, a reading resolution 1102, and a single-side/double-side setting 1103 for setting whether the original document is single-sided or double-sided.

Next, in 903, the communication apparatus 120 accepts the processing condition of the transmission destination via the user interface screen shown in FIG. 11. For example, the processing condition of the transmission destination includes “print”, “storage”, and “storage+print”. Reference numerals 1104, 1105, and 1106 denote buttons for setting “print”, “storage”, and “storage+print”, respectively. The processing condition set here and the transmission file are transmitted to the destination which is the communication apparatus 122 (receiving terminal). The communication apparatus 122 which receives the transmission file and the processing condition processes the received file on the basis of the processing condition.

When “print” is selected as the processing condition, the destination communication apparatus 122 transfers the received file to an image forming device (for example, multifunction apparatus 114) which is registered as a device for performing printing in advance. The multifunction apparatus 114 prints the received file. If “print” is set and the printing cannot be performed by the multifunction apparatus 114 (because of power-off of the multifunction apparatus or a network error), the communication apparatus 122 stores the received file into the storage device of the communication apparatus 122. When “storage” is selected as the processing condition, the destination communication apparatus 122 stores the received file into the storage device of the communication apparatus 122. When “storage+print” is selected as the processing condition, the destination communication apparatus 122 transfers the received file to the image forming device (for example, multifunction apparatus 114) which is registered as a device for performing printing in advance.

If the scan button 1107 is operated after the above processing condition is set, the scanner unit 422 of the multifunction apparatus 112 reads an original document set on the original document placement table or the automatic original document feeder. The multifunction apparatus 112 transmits image data of the original document read by the scanner unit 422 to the communication apparatus. The communication apparatus 120 receives the image data transmitted from the multifunction apparatus 112, and stores the image data into the storage device 212 as a transmission file (904). By repeating the processing of 902 and 903, an image of another original document can be further registered as a transmission file. In this embodiment, the processing condition is set for each transmission file, in other words, for each image of original document scanned as one job. When a transmission document list button 1004 in FIG. 10 is operated, a list of files registered as transmission files is displayed.

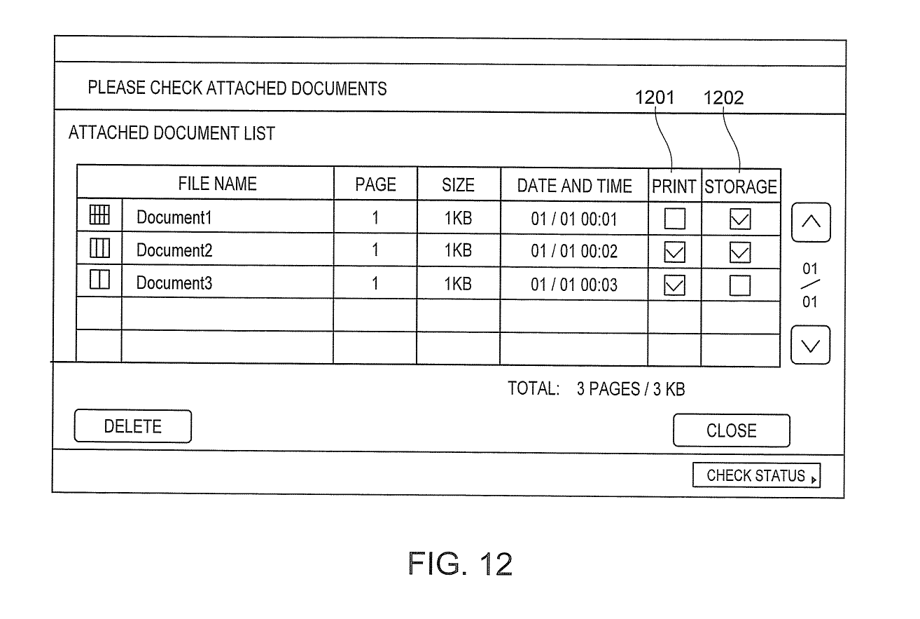

FIG. 12 is an example of a list display screen of the files registered as transmission files. In the list screen, a file name, the number of scanned pages, size, and information of the date of the scan are displayed. The list screen includes check buttons 1201 and 1202 for checking or changing the processing condition of the transmission destination for each file registered as a transmission file. The check button 1201 sets enable/disable of the “print” processing. The check button 1202 sets enable/disable of the “storage” processing.

In 905 in FIG. 9, the communication apparatus 120 accepts a registration of an address of the transmission destination via the operation panel 416 of the multifunction apparatus 112. The user directly inputs the address of the transmission destination via the operation panel 416 of the multifunction apparatus 112, or registers the destination address by selecting the destination address from an address book or a transmission/reception history stored in the communication apparatus 120. The address book used to select the destination address is not limited to the address book stored in the communication apparatus 120, and the destination address may be selected from an address book stored in the user terminal 116 or the multifunction apparatus 112. A plurality of destination addresses may be registered at the same time. As shown in FIG. 10, as an example in this embodiment, a telephone number XXXXXXXXXX of the communication apparatus 122 is registered as a destination address.

Reference numeral 1003 in FIG. 10 denotes a button for setting the “transmission with password” function. The “transmission with password” function is described in the first embodiment, so that the description will not be repeated. Reference numeral 1004 in FIG. 10 denotes a transmit button for instructing transmission of the transmission files to the communication apparatus 120.

In 906 in FIG. 9, the control unit 202 of the communication apparatus 120 determines whether the transmission instruction is received. When the transmission instruction is received (Yes in 906), in 907, the control unit 202 of the communication apparatus 120 determines whether the setting of “transmission with password” is enabled.

When the setting of “transmission with password” is disabled (No in 907), in 910, the control unit 202 of the communication apparatus 120 transmits the transmission files and the processing conditions of the transmission destination to the communication apparatus 122 via the communication I/F 218.

When the setting of “transmission with password” is enabled (Yes in 907), the control unit 202 of the communication apparatus 120 compresses the files to be transmitted into a single file in a predetermined format with the inputted password (908). For example, the control unit 202 compresses the files to be transmitted into a single file and encrypts the file by using the inputted password. The control unit 202 of the communication apparatus 120 creates a file name of the compressed file by adding an extension of the compression method to the file name of the first file (the file registered earliest) in the list of the files to be transmitted. On the receiving terminal side, a user who receives the password in a different way such as e-mail inputs the password when decompressing the file. If the inputted password is correct, the compressed file is decompressed into the original plurality of files. In addition, in the above mentioned example, the file name of the compressed file is the file name adding an extension of a compression method to the file name of the top front of a file list (earliest registered file) to be transmitted. It does not apply only the top front file of the list, it may be second or later one of the list or the last one of the list. Further, to input arbitrarily the file name by a user, a screen which urges to input a file name may be displayed and a user may input the file name. Additionally, a user may select a top front one, a second one or last one among a file name list.

Subsequently, in 909, the control unit 202 of the communication apparatus 120 sets “storage” to the processing condition of the transmission destination regardless of the processing condition of the transmission destination set in 903. Therefore, when “transmission with password” is enabled, even if the user sets the processing condition in advance, the destination communication apparatus 122 automatically stores the received file into the storage device. Next, in 910, the control unit 202 of the communication apparatus 120 transmits the transmission files and the processing conditions to the communication apparatus 122 via the communication I/F 218.

According to the above-described embodiment, when securing the security of the file to be transferred, the communication apparatus on the transmitting side obtains image data of the scanned original document from the multifunction apparatus, automatically compresses and encrypts the image data, and transfers the file to the receiving terminal as a file with a password. Therefore, after a user instructs the multifunction apparatus to scan the original document, the user need not instruct any device to compress the transmission file, so that the usability is good. Further, according to this embodiment, the communication apparatus can obtain image data of the original document from the multifunction apparatus as a separate job and collectively transmit a plurality of files in the same transmission processing. Therefore, the user need not set transmission processing for each transmission file, so that the usability is good.

### Third Embodiment

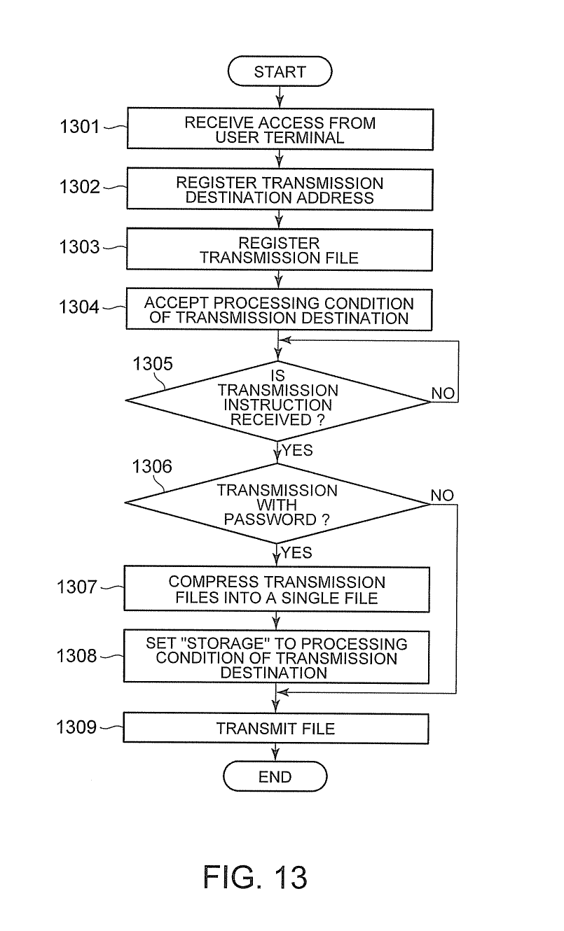

Next, a case in which file transmission is instructed from the user terminal 116 will be described. FIG. 13 is a flowchart for explaining a case in which the user terminal 116 instructs the communication apparatus 120 to transmit a file by using a Web browser function.

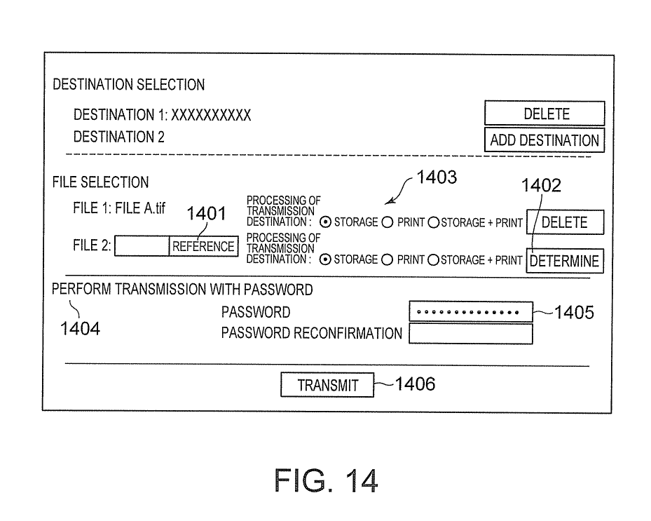

In 1301 in FIG. 13, the user terminal 116 accesses the communication apparatus 120 by using the Web browser function. In 1302, the communication apparatus 120 accepts a registration of an address of the transmission destination via a user interface of the user terminal 116. The user directly inputs the address of the transmission destination or registers the destination address by selecting the destination address from the address book or the transmission/reception history stored in the communication apparatus 120. The address book used to select the destination address is not limited to the address book stored in the communication apparatus 120, and the destination address may be selected from an address book stored in the user terminal 116 or the multifunction apparatus 112. A plurality of destination addresses may be registered at the same time. In this embodiment, as an example, as shown in FIG. 14, the telephone number XXXXXXXXXX of the communication apparatus 122 is registered as the destination address.

In 1303, the communication apparatus 120 accepts a registration of a file to be transmitted. For example, on the basis of a user instruction, a directory is specified in which a file transmitted from the user terminal 116, the multifunction apparatus 112, or the server is stored. Subsequently, when the communication apparatus 120 receives an instruction for determining the transmission file from the user terminal 116, the communication apparatus 120 receives the transmission file from the device that stores the file and stores the transmission file into the storage device 212.

FIG. 14 is an example of a user interface screen displayed on the display unit 328 to instruct the file transmission from the user terminal 116 by using a Web browser function. By selecting a “reference” button 1401 to select the transmission file, the directory in which the file to be transmitted is stored is specified. Subsequently, by selecting a “determination” button 1402, the specified file is transmitted from the device that stores the file to the communication apparatus 120, and the file is stored into the storage device 212 of the communication apparatus 120. The file 1 in FIG. 14 indicates a state in which a transmission file whose name is file A is registered.

In 1304 in FIG. 13, the communication apparatus 120 accepts a processing condition indicating how the file to be transmitted is processed in the transmission destination via the user interface of the user terminal 116. As shown in FIG. 14, for example, the processing condition 1403 of the transmission destination includes “storage”, “print”, and “storage+print”. The processing condition 1403 set here and the transmission file are transmitted to the destination which is the communication apparatus 122. The communication apparatus 122 which receives the transmission file and the processing condition 1403 processes the received file on the basis of the processing condition 1403. In this embodiment, the processing condition 1403 is set for each transmission file.

Reference numeral 1404 in FIG. 14 denotes a check box for setting enable/disable of “transmission with password”. When the check box 1404 is checked and “transmission with password” is enabled, the input field 1405 is enabled and a password can be accepted. Reference numeral 1406 in FIG. 14 denotes an icon for instructing the communication apparatus 120 to perform file transmission processing.

In 1305, the control unit 202 of the communication apparatus 120 determines whether the transmission instruction is received. When the transmission instruction is received (Yes in 1305), in 1306, the control unit 202 of the communication apparatus 120 determines whether the setting of “transmission with password” is enabled. For example, the control unit 202 determines whether the check box 1404 in FIG. 14 is checked and a password is inputted into the input field 1405.

When the setting of “transmission with password” is disabled (No in 1306), in 1309, the control unit 202 of the communication apparatus 120 transmits the transmission file and the processing condition 1403 to the communication apparatus 122 via the communication I/F 218.

When the setting of “transmission with password” is enabled (Yes in 1306), the control unit 202 of the communication apparatus 120 compresses the files to be transmitted into a single file in a predetermined format with the password inputted into the input field 1405 (1307). For example, the control unit 202 compresses the files to be transmitted into a single file and encrypts the file by using the password inputted into the input field 1405. The control unit 202 of the communication apparatus 120 creates a file name of the compressed file by adding an extension of the compression method to the file name of the first file (the file registered first) in the list of the files to be transmitted.

Subsequently, in 1308, the control unit 202 of the communication apparatus 120 sets “storage” to the processing condition 1403 of the transmission destination regardless of the processing condition 1403 of the transmission destination set in 1304. Therefore, when the check box 1404 is checked and “transmission with password” is enabled, the destination communication apparatus 122 automatically stores the received file into the storage device regardless of the setting of the processing condition 1403. Next, in 1309, the control unit 202 of the communication apparatus 120 transmits the transmission file and the processing condition 1403 to the communication apparatus 122 via the communication I/F 218.

According to the above-described embodiment, file transmission can be instructed from the user terminal. When securing the security of the file to be transferred, the communication apparatus on the transmitting side obtains an uncompressed media file from an external device such as the user terminal or the multifunction apparatus, automatically compresses and encrypts the image data, and transfers the file to the receiving terminal as a file with a password. Therefore, it is not necessary to issue an additional instruction for compressing the transmission file, so that the usability is good. Further, according to this embodiment, the communication apparatus can obtain a plurality of files from external devices and collectively transmit a plurality of files in the same transmission processing. Therefore, the user need not set transmission processing for each transmission file, so that the usability is good. On the receiving terminal side, a user who receives the password in a different way such as e-mail inputs the password when decompressing the file. If the inputted password is correct, the compressed file is decompressed into the original plurality of files.

Although, in the above-described embodiments, a case is described in which the communication apparatus is a device other than the multifunction apparatus, it is not limited to this. For example, a main body that performs an operation of the communication apparatus is included in the multifunction apparatus, and thereby a device in which the communication apparatus and the multifunction apparatus are integrated together may be used. In this case, the communication apparatus obtains image data of a file to be transmitted by using a scanner or the like.

A main body that performs an operation is a main body related to a computer, such as, for example, hardware, a complex body of hardware and software, software, and software in execution. Although main bodies that perform an operation are, for example, a process executed on a processor, a processor, an object, an execution file, a thread, a program, and a computer, they are not limited to these. For example, a multifunction apparatus, a processing device, and an application executed on these may be a main body that performs the operation. Processes and threads may implement a plurality of main bodies that performs the operation. The main body that performs the operation may be included in one document processing device, or the main bodies are distributed to a plurality of document processing devices.

Although, in the above-described embodiments, a case is described in which a function that implements the invention is previously recorded inside the device, it is not limited to this, and the same function may be downloaded from a network to the device, or a recording medium storing the same function may be installed in the device. The recording medium may have any form as long as the recording medium, such as a CD-ROM, can store a program and can be read by the device. The function obtained previously by the installation or download as described above may realize the function in cooperation with the OS (Operating System) and the like inside the device.

What is claimed is:

1. A communication apparatus comprising:
an interface for connecting with an external device and a transmission destination terminal via a network;
a memory for storing at least one address of a transmission destination and at least one file to be transmitted which are obtained from the external device via said interface; and
a controller for determining whether a password for encrypting a transmission file in said memory is obtained when said controller receives a transmission instruction of the file via said interface, and when the password is obtained, encrypting the transmission file by using the obtained password, and transmitting the encrypted transmission file to the transmission destination terminal of the address via said interface.

2. The communication apparatus according to claim 1, wherein when said controller receives the password via said interface, said controller automatically compresses the file to be transmitted and encrypts the file by using the obtained password, and said controller transmits the file to the transmission destination terminal of the address as the file with the password.

3. The communication apparatus according to claim 2, wherein, when said controller receives the password via said interface, said controller automatically compresses a plurality of files to be transmitted into a single file and encrypts the file by using the obtained password, and said controller transmits the file to the transmission destination terminal of the address as the single file with the password.

4. The communication apparatus according to claim 3, wherein, when said controller compresses a plurality of files into the single file, said controller changes a file name of the compressed file to the file name obtained by adding an extension of the compression method to the file name of the file which is stored earliest in said memory as the transmission file among the plurality of files.

5. The communication apparatus according to claim 4, wherein the external device is a multifunction apparatus which scans an original document and generates image data, and, after said controller receives a file transmission instruction via said interface, said controller obtains the image data via said interface and determines whether there is the password for encrypting the image data, and when there is the password, encrypts and converts the image data into a compressed file with the password by using the password and transmits the compressed file to the transmission destination terminal of the address.

6. A communication method for transmitting a file to a destination terminal via a network, the communication method comprising:
a destination acquiring step of acquiring an address of the destination terminal to which the file is transmitted;
a file acquiring step of acquiring the file to be transmitted to the destination terminal;
an encrypting step of encrypting the acquired file; and
a transmitting step of transmitting the encrypted file to the destination terminal according to a transmission instruction.

7. The communication method according to claim 6, wherein the file is encrypted by said encrypting step and the encrypted file is transmitted to the destination terminal after receiving the transmission instruction.

8. The communication method according to claim 6, wherein said encrypting step further includes determining whether the password is acquired, when it is determined that the password is acquired, the file is encrypted by using the password.

9. The communication method according to claim 8, wherein said transmission step further includes compressing the files in a predetermined format, encrypting the files by using the password after receiving the transmission instruction.

10. The communication method according to claim 6, wherein, in the case of having a plurality of acquired file, the files is compressed into a single file in a predetermined format.

11. The communication method according to claim 6, further comprising
an attribute information transmitting step of transmitting an attribute for a job executed at the destination terminal.
a processing condition inputting step of inputting a processing condition at the destination terminal,
wherein the processing condition includes print processing and storage processing of the file to be transmitted at the destination terminal, and the processing condition is transmitted to the destination terminal in the attribute information transmitting step.

12. The communication method according to claim 11, further comprising:
a determining step of determining whether the file to be transmitted is a file encrypted by the encrypting step or a file that is not encrypted,
a processing condition change transmitting step of, when the file is determined to be an encrypted file, even if the processing condition inputted in the processing condition inputting step is the print processing, changing the processing condition to the storage processing and transmitting the processing condition to the destination terminal.

13. The communication method according to claim 9, wherein when a plurality of the files is compressed into the single file in the compressing step, a file name of the compressed file is obtained by adding an extension of the compression method to the file name of the file that is stored earliest as a transmission file among the plurality of files.

14. The communication method according to claim 9, wherein said transmission step further includes a establishing communication step for establishing a connection to the destination terminal, and a file transmission step for transmitting the files which is acquired by said file acquiring step, and a plurality of the files is compressed together.

15. The communication method according to claim 12, wherein the destination terminal includes an image forming apparatus which prints the transmitted file, said image forming apparatus prints the transmitted file when the transmitted processing condition is the printing process in the processing condition inputting step, and said image forming apparatus returns the encrypted file to the original file when the input password is correct.

16. The communication method according to claim 8, further comprising a file protected by a password transmission instruction unit for transmitting the file protected by the password, and a general transmission instruction unit for transmitting a general transmission, wherein when a file protected by password transmission instruction is instructed, the file is encrypted with the acquired password and automatically transmitted.

17. A multifunction apparatus which scans an original document and transmits the scanned original document to a destination terminal, the multifunction apparatus comprising:
a generating unit for scanning the original document and generating a file including image data;
a registering unit for registering the destination terminal to which the file is transmitted;
a file registering unit for registering the file to be transmitted to the destination terminal;
an encrypting unit for encrypting the registered file; and
a transmitting unit for transmitting the encrypted file to the registered destination terminal.

18. The multifunction apparatus according to claim 17, wherein, when there is a plurality of the registered files, the encrypting unit compresses the files into a single file in a predetermined format and encrypts the file by using the password.

19. The multifunction apparatus according to claim 17, further comprising:
an input unit for inputting a processing condition at the destination terminal,
wherein the processing condition includes print processing and storage processing of the file to be transmitted at the destination terminal, and
said multifunction apparatus determines whether the file to be transmitted is a file encrypted by the encrypting unit or a file that is not encrypted, and when the file is determined to be an encrypted file, even if the processing condition inputted by the input unit is the print processing, said multifunction apparatus changes the processing condition to the storage processing and transmits the processing condition to the destination terminal.

20. The multifunction apparatus according to claim 18, further comprising:
a button for setting a “transmission with password” function; and
a transmission button for instructing file transmission processing,
wherein a screen in which a password is inputted is displayed by operating the button, and when transmission processing is instructed by the transmission button after the password is inputted, the file is automatically encrypted/compressed by using the password and transmitted.
